(19) United States
(12) Patent Application Publication
(10) Pub. No.: US 2025/0265856 A1
(43) Pub. Date: Aug. 21, 2025

(54) IMAGE PROCESSING SYSTEM

(71) Applicant: KYOCERA Document Solutions Inc., Osaka (JP)

(72) Inventors: Noa Kaneda, Osaka (JP); Kanako Morimoto, Osaka (JP); Kazunori Tanaka, Osaka (JP); Takeo Shimizu, Osaka (JP)

(21) Appl. No.: 19/052,011

(22) Filed: Feb. 12, 2025

(30) Foreign Application Priority Data
Feb. 20, 2024 (JP) 2024-023409

(51) Int. Cl. G06V 30/414; G06V 10/764; G06V 30/413

(52) U.S. Cl. CPC G06V 30/414; G06V 10/764; G06V 30/413

(57) ABSTRACT

An image processing system includes a target image acquiring unit, an object detecting unit, an area extracting unit, and a process executing unit. The target image acquiring unit acquires as a target image a document image of a document. The object detecting unit detects area specifying objects additionally written to the document by handwriting in the document image using object detection with a learner for which machine learning has been performed, and derives respective confidences of the detected area specifying objects. The area extracting unit determines a pair of area specifying objects that specify a rectangular area among the detected area specifying objects, and extracts the rectangular area on the basis of positions of the area specifying objects in the determined pair. The process executing unit executes a predetermined process for the rectangular area extracted in the target image.

### CROSS-REFERENCE TO RELATED APPLICATIONS

This application relates to and claims priority rights from Japanese Patent Application No. 2024-023409, filed on Feb. 20, 2024, the entire disclosures of which are hereby incorporated by reference herein.

### BACKGROUND

### 1. Field of the Present Disclosure

The present disclosure relates to an image processing system.

### 2. Description of the Related Art

Regarding a document image obtained by scanning a document that includes a process list of process items “Delete”, “Acquire” and “Restrict”, an image processing apparatus determines a process item specified with a specific color in the process list, and performs the specified process item for a part surrounded by the specific color or a part filled in with the specific color in the document image.

Further, an image processing apparatus (a) separates a handwritten part from a document image of a document, (b) determines whether the handwritten part is a surrounding line that surrounds a target area or a classification symbol that classifies a target area, and (c) classifies an image of the target area with the classification symbol.

It is conceivable to determine a target area of an arbitrary shape specified with a handwritten area-specifying object such as a surrounding line as mentioned, and performs a predetermined image process for the target area. In such a case, if the area specifying object is a handwritten object, there is fluctuation on a shape or the like of the area specifying object, and therefore, the area specifying object may not be properly detected in the target image.

### SUMMARY

An image processing system according to an aspect of the present disclosure includes a target image acquiring unit, an object detecting unit, an area extracting unit, and a process executing unit. The target image acquiring unit is configured to acquire as a target image a document image of a document. The object detecting unit is configured to detect area specifying objects additionally written to the document by handwriting in the document image using object detection with a learner for which machine learning has been performed, and derive respective confidences of the detected area specifying objects. The area extracting unit is configured to determine a pair of area specifying objects that specify a rectangular area among the detected area specifying objects, and extract the rectangular area on the basis of positions of the area specifying objects in the determined pair. The process executing unit is configured to execute a predetermined process for the rectangular area extracted in the target image.

These and other objects, features and advantages of the present disclosure will become more apparent upon reading of the following detailed description along with the accompanied drawings.

### BRIEF DESCRIPTION OF THE DRAWINGS

FIG. 1 shows a block diagram that indicates a configuration of an image processing system in an embodiment of the present disclosure;

FIG. 2 shows a diagram that indicates an example of a target image that includes an area specifying object;

FIG. 3 shows a diagram that indicates examples of area specifying objects of plural shape types;

FIG. 4 shows a diagram that explains an area specifying object determined in the target image shown in FIG. 2;

FIG. 5 shows a diagram that explains a representative angle of an area specifying object of each shape type;

FIG. 6 shows a diagram that indicates an example of plural first area specifying objects and plural second area specifying objects detected in a target image;

FIG. 7 shows a diagram that indicates an example of rectangular areas determined from the area specifying objects shown in FIG. 6;

FIG. 8 shows a diagram that indicates an example of a document image newly generated by rearranging an image of a rectangular area extracted from a target image;

FIG. 9 shows a diagram that indicates another example of a document image newly generated by rearranging an image of a rectangular area extracted from a target image; and

FIG. 10 shows a flowchart that explains a behavior of the image processing system shown in FIG. 1.

### DETAILED DESCRIPTION

Hereinafter, an embodiment according to an aspect of the present disclosure will be explained with reference to drawings.

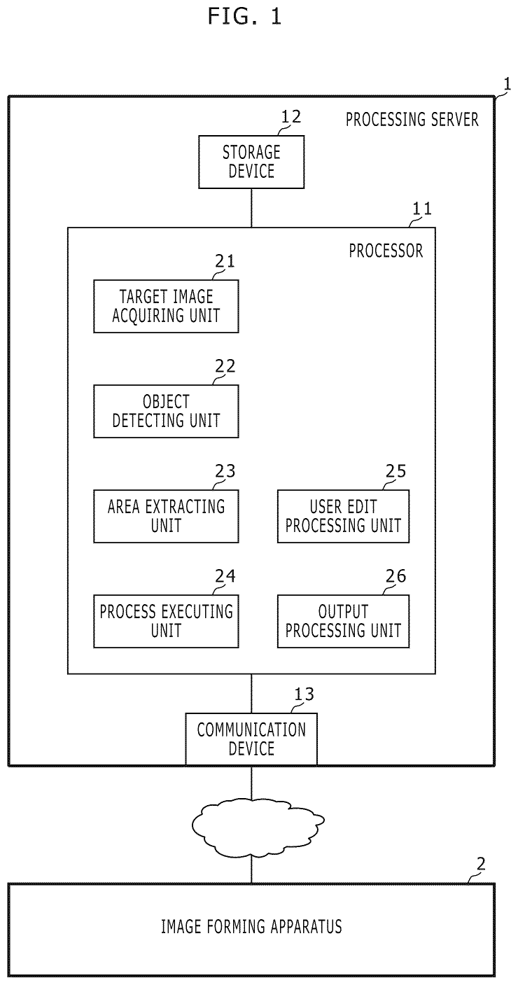

FIG. 1 shows a block diagram that indicates a configuration of an image processing system in an embodiment of the present disclosure. The image processing system includes a processing server 1 and an image forming apparatus 2 (multi function peripheral or the like), capable of communication through a network with each other.

The processing server 1 includes a processor 11, a storage device 12, and a communication device 13.

The processor 11 includes a computer, and executes a program with the computer and thereby, acts as sorts of processing units. Specifically, the computer includes a CPU (Central Processing Unit), a ROM (Read Only Memory), a RAM (Random Access Memory) and the like, loads a program stored in the ROM or the storage device 12, executes the program with the CPU, and thereby acts as sorts of processing units. Further, the processor 11 may include an ASIC (Application Specific Integrated Circuit) that performs as a specific processing unit.

The storage device 12 is a non-volatile storage device such as flash memory, and stores the image processing program and data required for a process mentioned below. In the storage device 12, system setting data is stored. The system setting data includes parameters of a learner mentioned below.

The communication device 13 such as network interface or a peripheral device interface is a device that performs data communication with an external device such as the image forming apparatus 2.

Meanwhile, the image forming apparatus 2 includes an image scanning device, a communication device, an operation panel and the like, generates as a target image a document image from a document using the image scanning device, and using the communication device, transmits the target image to the processing server 1 and receives the processed target image.

In the processing server 1, the processor 11 acts as a target image acquiring unit 21, an object detecting unit 22, an area extracting unit 23, a process executing unit 24, a user edit processing unit 25, and an output processing unit 26, as the aforementioned processing units.

The target image acquiring unit 21 acquires as a target image (image data of) a document image of a document from the storage device 12, the communication device 13 or the like, and stores the target image into the RAM or the like. For example, this document is a print product outputted by a printing device, and this document image is an image obtained by scanning such document using an image scanning device. For example, this document is a business form or a flyer.

The object detecting unit 22 detects an area specifying object additionally written to the document by handwriting in the document image using object detection with a learner for which machine learning has been performed (such as YOLO (You Only Look Once), SSD (Single Shot MultiBox Object Detector), FasterR-CNN (Regions with Convolutional Neural Networks) or the like). For each of the detected objects, as output data, this learner derives a classification (which one of an area specifying object and an object other than area specifying object), a bounding box (i.e. a position and a size of it), and a confidence of the classification (any value from 0 to 1).

The handwritten area-specifying object is an individual foreground image other than a background. Further, if a size of the document image is different from a size of input data of this learner (i.e. objection detection model), the document image is converted to get the same size as the input data size of the leaner (i.e. objection detection model). For example, if a size of the document image is an A4 size of 300 dpi, i.e. 2480 pixels by 3507 pixels, and the input data size is 640 pixels by 640 pixels, then resolution of the document image is converted, and thereby a size of the document image becomes 640 pixels by 640 pixels.

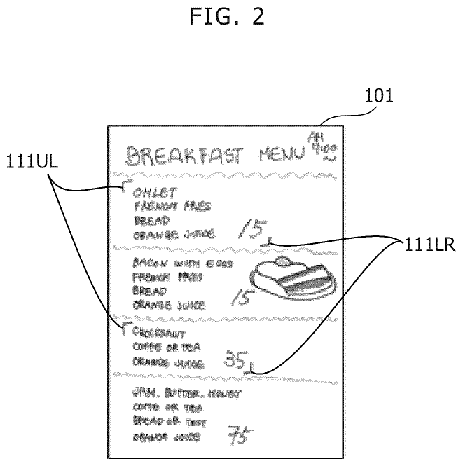

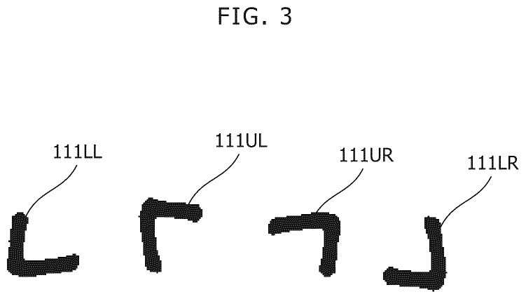

FIG. 2 shows a diagram that indicates an example of a target image that includes an area specifying object. FIG. 3 shows a diagram that indicates examples of area specifying objects of plural shape types. The target image 101 shown in

FIG. 2, for example, includes area specifying objects 111UL and 111LR. As area specifying objects that can be detected by the object detecting unit 22, area specifying objects 111LL, 111UL, 111UR and 111LR of shape types as shown in FIG. 3, for example, are set. Therefore, the machine leaning is performed for the leaner using area specifying objects having these shape types.

As shown in FIG. 2, for example, the area specifying object 111UL and the area specifying object 111LR make a pair, the area specifying object 111LL and the area specifying object 111UR make a pair, these pairs specify rectangular areas, respectively, and images of the rectangular areas are set as targets of an image process mentioned below. Specifically, one of the area specifying objects in the pair is a first area specifying object that specifies a first angle, and the other of the area specifying objects in the pair is a second area specifying object that specifies a second angle among four angles of the rectangular area such that the second angle is an opposite angle to the first angle.

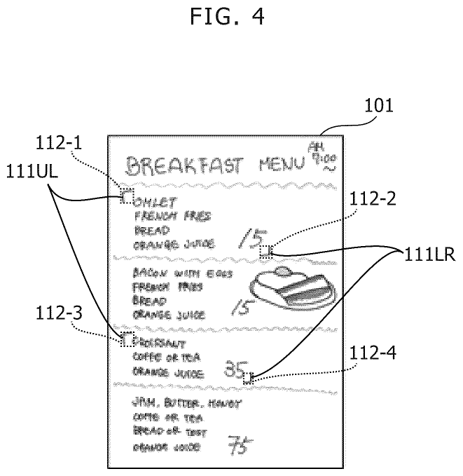

FIG. 4 shows a diagram that explains an area specifying object determined in the target image shown in FIG. 2. As shown in FIG. 4, for example, the object detecting unit 22 determines using the aforementioned object detection bounding boxes 112-1 to 112-4 of the area specifying objects 111UL and 111LR (i.e. determines a position and a size of each of the objects 111UL and 111LR).

Further, for the leaner the machine learning has been performed using as training data plural document images of which each document image includes a pair of area specifying objects that specify a rectangular area. The area specifying objects included by the plural document images in the training data (here, the area specifying objects 111LL, 111UL, 111UR and 111LR of four shape types as mentioned) have plural colors, plural line width, and plural shapes. Consequently, a writing implement used to write an area specifying object on a document is not limited, and even if there is fluctuation of a shape of it due to handwriting, the area specifying object is properly detected, and in addition, correspondingly to various positional relationships between area specifying objects in the pairs, the area specifying objects are properly detected.

The area extracting unit 23 determines a pair of area specifying objects that specify a rectangular area among the detected area specifying objects on the basis of the aforementioned confidences, and extracts the rectangular area on the basis of positions of the area specifying objects in the determined pair.

Specifically, the learner of the object detecting unit 22 distinctively detects the aforementioned first area specifying object and the aforementioned second area specifying object, and the area extracting unit 23 determines a pair of the first area specifying object and the second area specifying object, and extracts the rectangular area on the basis of positions of the first area specifying object and the second area specifying object in the determined pair.

Here, the area extracting unit 23 extracts an image inside of a bounding box of each area specifying object from the target image, binarizes the extracted image, and thereby generates a binarized image; detects outlines (boundary lines between the objects and a background) in the binarized image, determines bounding boxes of the outlines, considers an outline of which a bounding box has a largest area as an outline of an area specifying object, and identifies this bounding box as a bounding box of the area specifying object. Here, this binarization is performed in accordance with an existing method such as Otsu's binarization method or k-means method (n=2).

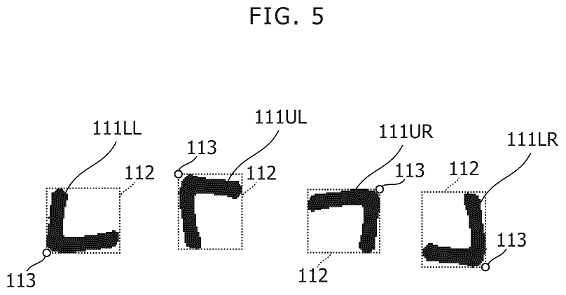

FIG. 5 shows a diagram that explains a representative angle of an area specifying object of each shape type. Specifically, as shown in FIG. 5, for example, regarding an area specifying object of each shape type, one angle 113 among four angles of the bounding box 112 is set as a representative angle, and the area unit 23 extracting considers a representative angle of the first area specifying object as a first angle, considers a representative angle of the second area specifying object as a second angle opposite to the first angle, determines a rectangular area on the basis of the first and second angle, and extracts (an image) of the rectangular image.

Further, if the area extracting unit 23 determines plural pairs of area specifying objects that specifies plural rectangular areas among the detected area specifying objects, the area extracting unit 23 (a) determines plural combination patterns of the plural pairs on the basis of positions of the first area specifying objects and the second area specifying objects, (b) among the plural combination patterns, selects a combination pattern that has a largest sum of the confidences of the first and second area specifying objects, and (c) determines the plural pairs with the selected combination pattern.

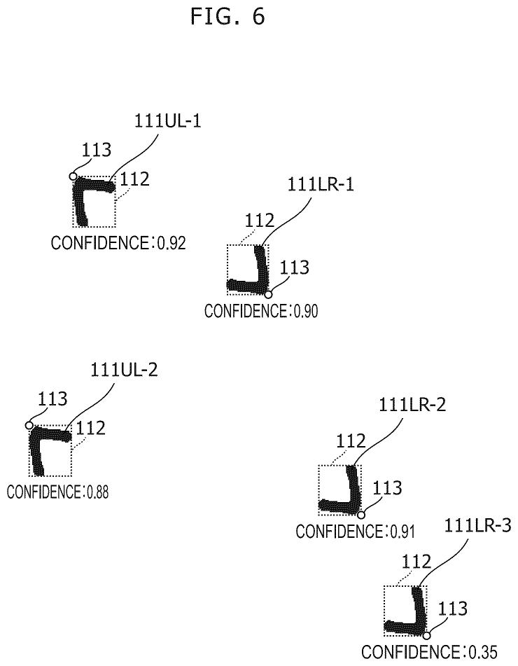

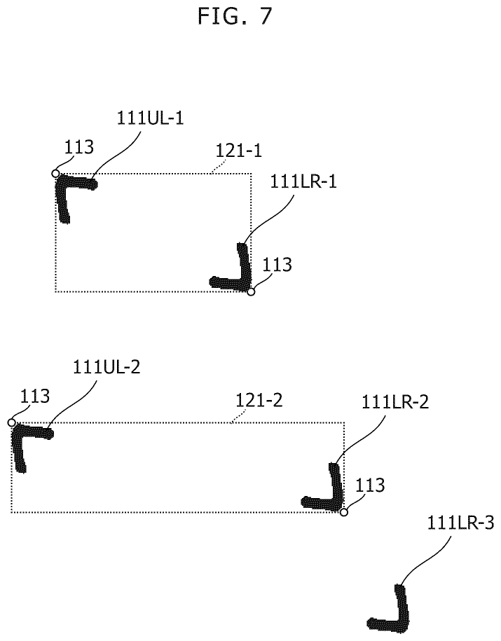

FIG. 6 shows a diagram that indicates an example of plural first area specifying objects and plural second area specifying objects detected in a target image. FIG. 7 shows a diagram that indicates an example of rectangular areas determined from the area specifying objects shown in FIG. 6. In FIG. 6, the area specifying objects 111UL-1 and 111UL-2 are the first area specifying objects, the area specifying objects 111LR-1 and 111LR-2, and 111LR-3 are the second area specifying objects, and a bounding box 112 and a confidence of each of the objects are derived by the object detecting unit 22.

In a case shown in FIG. 6, the area extracting unit 23 firstly determines combination patterns of plural pairs as follows. It should be noted that for a target area specifying object, correspondingly to a shape type of the target area specifying object, another area specifying object that makes a pair with the target area specifying object is restricted to one within a specific angle area of 90 degrees from the target area specifying object. Here, for the area specifying object 111UL-i (i=1,2), an area specifying object that makes a pair with the area specifying object 111UL-i is restricted to one located in a right and down direction from the area specifying object 111UL-i; and for the area specifying object 111LR-j (i=1, 2, 3), an area specifying object that makes a pair with the area specifying object 111LR-j is restricted to one located in a left and up direction from the area specifying object 111LR-j.
PATTERN #1: a pair of the area specifying objects 111UL-1 and 111LR-1, and a pair of the area specifying objects 111UL-2 and 111LR-2.
PATTERN #2: a pair of the area specifying objects 111UL-1 and 111LR-1, and a pair of the area specifying objects 111UL-2 and 111LR-3.
PATTERN #3: a pair of the area specifying objects 111UL-1 and 111LR-2, and a pair of the area specifying objects 111UL-2 and 111LR-3.
PATTERN #4: a pair of the area specifying objects 111UL-1 and 111LR-3, and a pair of the area specifying objects 111UL-2 and 111LR-2.

Further, the area extracting unit 23 derives a sum of the confidences of each of the patterns. A sum of the confidences of PATTERN #1 is 3.61 (=0.92+0.90+0.88+0.91), a sum of the confidences of PATTERN #2 is 3.05 (=0.92+0. 90+0. 88+0.35), a sum of the confidences of PATTERN #3 is 3.06 (=0.92+0.91+0.88+0.35), and a sum of the confidences of PATTERN #4 is 3.06 (=0.92+0.35+0.88+0.91).

Therefore, here, the area extracting unit 23 selects PATTERN #1 because PATTERN #1 has the largest sum, determines a pair of the area specifying objects 111UL-1 and 111LR-1 and a pair of the area specifying object 111UL-2 and 111LR-2, and determines and extracts rectangular areas 121-1 and 121-2 based on the pairs, as shown in FIG. 7, for example. In the extracted image, the area specifying objects are properly deleted. For example, even if the area specifying object 111LR-3 is obtained due to misdetection, the confidence of it is low, and therefore, a proper pair is determined on the basis of confidences.

Further, the process executing unit 24 performs a predetermined process for the rectangular area extracted in the target image 101.

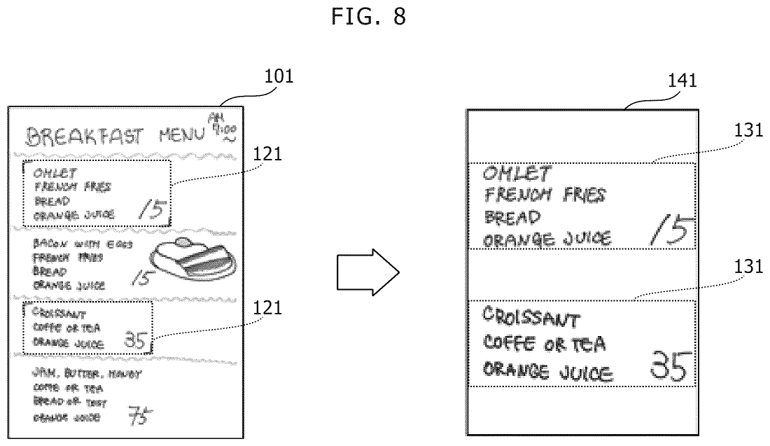

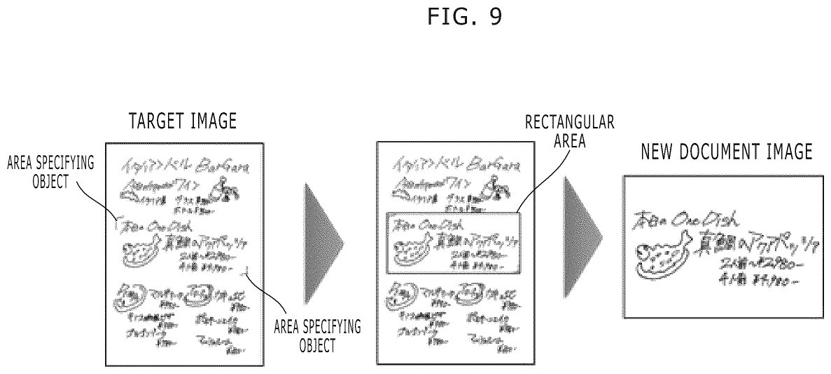

FIG. 8 shows a diagram that indicates an example of a document image newly generated by rearranging an image of a rectangular area extracted from a target image. FIG. 9 shows a diagram that indicates another example of a document image newly generated by rearranging an image of a rectangular area extracted from a target image.

As shown in FIG. 8, for example, the process executing unit 24 rearranges images 131 extracted from the rectangular area 121 determined in the target image 101 and thereby generates a new document image 141. Here, the images 131 are arranged (arrayed) in the document image 141 with a preset position and a preset size (for example, with left alignment of the primary scanning direction, center alignment of the secondary scanning direction, and 170% enlargement).

The aforementioned position and size may be specified by a user (i.e. a user operation or user setting). For example, the position and the size may be selected from (a) plural options for a position in the primary scanning direction, such as center align and left align, (b) plural options for a position in the secondary scanning direction, such as center align and top align, and (c) enlargement ratios from 100% to 200%, by a user operation or a user setting. The enlargement ratio as the size may be set as a maximum value not to exceed a value corresponding to a size of a print sheet for printing. Further, in FIG. 8, there are plural (two) rectangular areas 121, but as shown in FIG. 9, for example, one rectangular area may be extracted from one target image and rearranged to generate a new document image. Furthermore, as shown in FIG. 9, for example, the newly generated document image may be rotated so as to agree an orientation of it with an orientation of a print sheet used for printing.

Furthermore, on the basis of a user operation, the user edit processing unit 25 edits a processing result (the aforementioned new document image 141 or the like) obtained by the process executing unit 24. Specifically, the processing result is displayed to a user by the output processing unit 26, and then the user edit processing unit 25 edits the processing result on the basis of a user operation.

Furthermore, the output processing unit 26 outputs the aforementioned process result. For example, the output processing unit 26 transmits the processing result to the image forming apparatus 2, causes the image forming apparatus 2 to print the processing result, or stores the processing result into a predetermined storage device (the image forming apparatus 2, another server or the like).

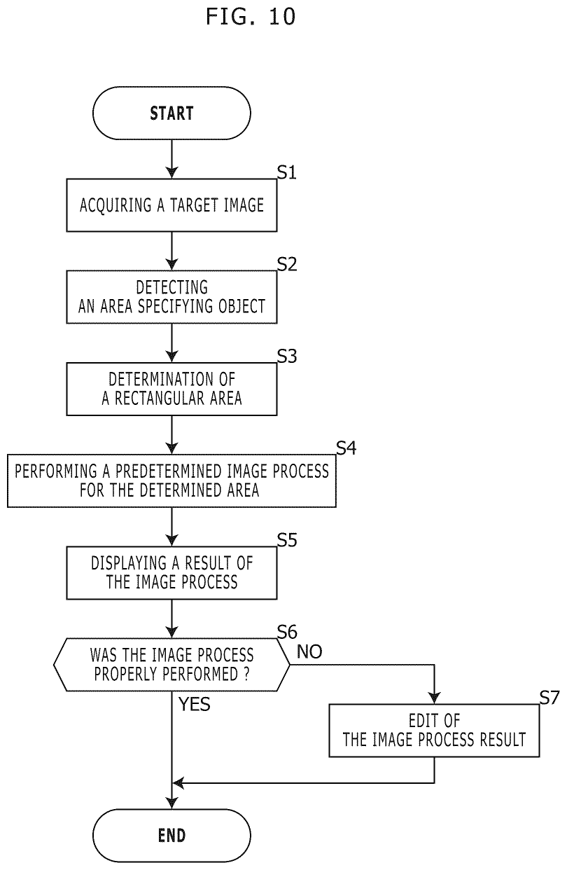

The following part explains a behavior of the aforementioned image processing system. FIG. 10 shows a flowchart that explains a behavior of the image processing system shown in FIG. 1.

The target image acquiring unit 21 acquires a target image (in Step S1). Here, the aforementioned area specifying object is additionally described by handwriting on a document printed by the image forming apparatus 2, and thereafter, a document image is obtained by scanning an image of the document, and the document image (image data) is transmitted as the target image from the image forming apparatus 2 to the processing server 1.

In the processing server 1, upon obtaining the target image, the object detecting unit 22 detects the area specifying object in the target image using object detection (in Step S2).

On the basis of the detected area specifying object, the area extracting unit 23 determines a rectangular area specified by a user with handwriting in the target image, and extracts the rectangular area from the target image (in Step S3).

Subsequently, the process executing unit 24 executes a predetermined process (generation of the aforementioned new document image or the like) based on the extracted rectangular area (in Step S4).

Afterward, the output processing unit 26 displays a processing result of the process to a user using the image forming apparatus 2, for example (in Step S5).

The user visually confirms the displayed processing result, determines whether the image process has been properly performed by the process executing unit 24 or not, and performs a user operation that indicates the determination result, to the image forming apparatus 2 (an input device of an operation panel of it). Further, if the user determined that the image process has not been properly performed, then the user performs a user operation for edit to the image forming apparatus (an input device of an operation panel of it). The image forming apparatus 2 informs the user edit processing unit 25 of the processing server 1 of these user operations.

The user edit processing unit 25 determines whether the image process has been properly performed or not on the basis of the information (in Step S6). If it is determined that the image process has been properly performed, then the output processing unit 26 outputs the processing result, if required.

Contrarily, if it is determined that the image process has not been properly performed, then the user edit processing unit 25 edits the processing result (the aforementioned new document image or the like) in accordance with a user operation (in Step S7). Afterward, the output processing unit 26 outputs the edited processing result.

As mentioned, in the aforementioned embodiment, the object detecting unit 22 detects area specifying objects additionally written to the document by handwriting in the document image using object detection with a learner for which machine learning has been performed, and derive respective confidences of the detected area specifying objects. The area extracting unit 23 determines a pair of area specifying objects that specify a rectangular area among the detected area specifying objects on the basis of the confidences, and extracts the rectangular area on the basis of positions of the area specifying objects in the determined pair. The process executing unit 24 performs a predetermined process for the rectangular area extracted in the target image.

Consequently, using object detection removes limitation on a writing implement used to write an area specifying object on a document, and the area specifying object to specify an image process target in the target image is properly detected.

It should be understood that various changes and modifications to the embodiments described herein will be apparent to those skilled in the art. Such changes and modifications may be made without departing from the spirit and scope of the present subject matter and d without diminishing its intended advantages. It is therefore intended that such changes and modifications be covered by the appended claims.

For example, in Embodiment 1 or 2, the user edit processing unit 25 may be installed in the image forming apparatus 2, rather than in the processing server 1. Further, the processing server 1 may be installed in the image forming apparatus 2.

What is claimed is:

1. An image processing system, comprising:
a target image acquiring unit configured to acquire as a target image a document image of a document;
an object detecting unit configured to detect area specifying objects additionally written to the document by handwriting in the document image using object detection with a learner for which machine learning has been performed, and derive respective confidences of the detected area specifying objects;
an area extracting unit configured to determine a pair of area specifying objects that specify a rectangular area among the detected area specifying objects, and extract the rectangular area on the basis of positions of the area specifying objects in the determined pair; and
a process executing unit configured to execute a predetermined process for the rectangular area extracted in the target image.

2. The image processing system according to claim 1, wherein the area specifying objects includes a first area specifying object that specifies a first angle and a second area specifying object that specifies a second angle among four angles of the rectangular area, the second angle being an opposite angle to the first angle;
the learner distinctively detects the first area specifying object and the second area specifying object; and
the area extracting unit determines a pair of the first area specifying object and the second area specifying object, and extracts the rectangular area on the basis of positions of the first area specifying object and the second area specifying object in the determined pair.

3. The image processing system according to claim 2, wherein the area extracting unit considers one of four angles of a bounding box of the first area specifying object as the first angle, and considers one of four angles of a bounding box of the second area specifying object as the second angle.

4. The image processing system according to claim 2, wherein if the area extracting unit determines plural pairs of area specifying objects that specifies plural rectangular areas among the detected area specifying objects, the area extracting unit (a) determines plural combination patterns of the plural pairs on the basis of positions of the first area specifying objects and the second area specifying objects, (b) among the plural combination patterns, selects a combination pattern that has a largest sum of the confidences of the first and second area specifying objects, and (c) determines the plural pairs with the selected combination pattern.

5. The image processing system according to claim 1, wherein for the leaner the machine learning has been performed using as training data plural document images of which each document image includes a pair of area specifying objects that specify a rectangular area; and
the area specifying objects included by the plural document images in the training data have plural colors, plural line width, and plural shapes.
